(19) United States
(12) Patent Application Publication
(10) Pub. No.: US 2024/0208192 A1
(43) Pub. Date: Jun. 27, 2024

(54) FILM COMPRISING POLYAMIDE POLYURETHANE LAYER

(71) Applicant: 3M INNOVATIVE PROPERTIES COMPANY, St. Paul, MN (US)

(72) Inventors: Yongshang Lu, Woodbury, MN (US); Charlie C. Ho, Woodbury, MN (US)

(21) Appl. No.: 17/909,843

(22) PCT Filed: Apr. 2, 2021
(86) PCT No.: PCT/IB2021/052785

§ 371 Date: Sep. 7, 2022

Related U.S. Application Data
(60) Provisional application No. 63/008,029, filed on Apr. 10, 2020.

(51) Int. Cl. B32B 27/40; B32B 7/12; B32B 37/06; B32B 37/12; B32B 37/15; B32B 37/24; B32B 37/26; B32B 38/00

(52) U.S. Cl. CPC B32B 27/40; B32B 7/12; B32B 37/06; B32B 37/12; B32B 37/153; B32B 37/24; B32B 37/26; B32B 38/164; B32B 2037/243; B32B 2037/268; B32B 2038/0076; B32B 2250/02; B32B 2250/24; B32B 2305/72; B32B 2307/51; B32B 2307/738; B32B 2375/00

(57) ABSTRACT

A multilayer film is described comprising a first film layer comprising an organic polymeric material, wherein the first film layer has an elongation of at least 250%; and a second film layer comprising a crosslinked polyurethane wherein the polyurethane comprises polymerized units of a polyamide. In some embodiments, the organic polymeric material of the first film layer comprises polyurethane. Also described is a method of protecting a surface of a motor vehicle and a method of making a multilayer protective film.

### BACKGROUND

Multilayer films that include one or more layers of a polyurethane material are known. Some of these films are disclosed in U.S. Pat. Nos. 10,213,922; 8,128,779; 8,551,285 (Ho); U.S. Pat. No. 6,607,831 (Ho); U.S. Pat. No. 5,405,675 (Sawka et al.): U.S. Pat. No. 5,468,532 (Ho et al.): U.S. Pat. No. 6,383,644 (Fuchs); as well as PCT Internat. Publ. No. WO 93/24551 A1 (Pears et al.). Some of these films have been used in surface protection applications. For example, film products that have been used to protect the painted surface of selected automobile body parts have been commercially available for years by 3M Company, St. Paul, MN, under the trade designations SCOTCHCAL. Such films include a thermoplastic polyester-based polyurethane layer that is backed by a pressure sensitive adhesive (PSA) on one major surface and covered by a water-based polyester-based or polycarbonate-based polyurethane layer on the opposite major surface.

### SUMMARY

Although various multilayer films have been described, industry would find advantage in films having improved properties such as high elongation in combination with resistance to asphalt, sunscreen, acids, and caustic soda.

In one embodiment, a multilayer film is described comprising a first film layer comprising an organic polymeric material, wherein the first film layer has an elongation of at least 250%; and a second film layer comprising a crosslinked polyurethane wherein the polyurethane comprises polymerized units of a polyamide. In some embodiments, the organic polymeric material of the first film layer comprises polyurethane.

In another embodiment, a method of protecting a surface of a motor vehicle is described comprising providing a multilayer film as described herein; and bonding the multilayer film to a surface of a motor vehicle by means of the adhesive.

In another embodiment, a method of making a multilayer protective film is described. The method comprises providing a first film layer comprising organic polymeric material, wherein the first film layer has an elongation of at least 200%; forming a second film layer comprising an at least partially crosslinked polyurethane wherein the polyurethane comprises polyamide oligomer moieties; and bonding the first film layer and second film layer.

### DETAILED DESCRIPTION

A multilayer (e.g. protective) film, is described comprising:

a first film layer comprising an organic polymeric material wherein the first film layer has an elongation of at least 200% and a second film layer comprising a crosslinked polyurethane wherein the polyurethane comprises polymerized units of a polyamide. In other words, the polyurethane of the second film layer may be characterized as a polyamide-based polyurethane. The second film layer may be characterized as a protective layer for the underlying first film layer.

With reference to FIG. 1 depicted in U.S. Pat. No. 8,551,285: an illustrative multilayer film 10 includes at least a first film layer 14 having an elongation of at least 200% and a second polyamide-based polyurethane layer 12. In some embodiments, the multilayer film may further comprise a (e.g. pressure sensitive) adhesive layer 16. An optional releasable carrier web or liner 18 may be releasably bonded so as to protect the surface of the second polyamide-based polyurethane layer 12. When the multilayer film comprises a pressure sensitive adhesive (PSA) layer 16 a release liner 20 is releasably bonded so as to protect the PSA layer 16. During use of the multilayer film 10, both the releasable carrier web or liner 18 and release liner 20 are removed.

Polyurethane layer 12 comprises is a dried and cured organic solvent-based or water-based polyurethane. Preferably, polyurethane layer 12 comprises a dried and cured aqueous-based polyurethane dispersion (i.e. PUD. The aqueous phase comprises a high concentration of water and optionally a low concentration of volatile organic solvent. In some embodiments, the concentration of volatile organic solvents is less than 15, 14, 13, 12, 11, 10, 9, 8, 7, 6, 5, 4, 3, 2, 1 or 0.5 wt. % based on the total amount of PUD.

In some embodiments, the second polyamide-based polyurethane layer comprises a dried and cured commercially available PUD available from Lubrizol under the trade designations Aptalon™W8100 and Aptalon™W8060.

According to the supplier literature Aptalon™W8060 is reported to have an elongation at break of 140% and Aptalon™W8100 is reported to have an elongation at break or 227%. However, it has been found that such polyamide-based polyurethane can provide much higher elongation 250%+ when coated on a high elongation film, even with the addition of crosslinker.

As known in the art and described for example in U.S. Pat. No. 9,988,555, amide linkages are formed from the reaction of a carboxylic acid group with an amine group or the ring opening polymerization of a lactam, e.g. where an amide linkage in a ring structure is converted to an amide linkage in a polymer.

Suitable amide forming monomers include dicarboxylic acids, diamines, aminocarboxylic acids and lactams. Suitable dicarboxylic acids are where the alkylene portion of the dicarboxylic acid is a cyclic, linear, or branched (optionally including aromatic groups) alkylene of 2 to 36 carbon atoms, optionally including up to 1 heteroatom per 3 or 10 carbon atoms, more typically from 4 to 36 carbon atoms (the diacid would include 2 more carbon atoms than the alkylene portion). Illustrative acids include dimer fatty acids, hydrogenated dimer acid, sebacic acid, etc. In some embodiments, diacids with longer chain alkylene groups can be preferred to provide polyamide repeat units with lower Tg value.

Suitable diamines include those with up to 60 carbon atoms, optionally including 1 additional heteroatom (i.e. in addition to the two nitrogen atoms) for each 3 or 10 carbon atoms of the diamine. Suitable diamines can comprise various cycloaliphatic or aromatic, including heterocyclic groups providing that one or both of the amine groups are secondary amines. Suitable diamines may have the formula

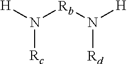

wherein Rb is a covalent bond or a divalent linking group typically comprising 2 to 36 carbon atoms and more at least 2, 3 or 4 carbon atoms ranging up to 12. The divalent linking group may comprise aliphatic and/or aromatic moieties. Such moieties may be linear, branched, or cyclic. In some embodiments, the divalent linking group may contain heteroatoms, as previously described. R_{c} and R_{d} are independently linear or branched alkyl group of 1 to 8 carbon atoms, more typically alkyl group of 1 or 2 carbon atoms ranging up to 4 carbon atoms. In some embodiments, R_{c} and R_{d} are covalently bonded forming a single linear or branched alkylene group of 1 to 8 carbon atoms In some embodiments, R_{c} or R_{d} is covalently bonded to Rb. 0 diamines include N,N′-bis(1,2,2-trimethylpropyl)-1,6-hexanediamine; N-methylaminoethanol; dihydroxy terminated, hydroxyl and amine terminated or diamine terminated poly(alkyleneoxide) where the alkylene has from 2 to 4 carbon atoms and having molecular weights from 100 to 2000; N,N′-diisopropyl-1,6-hexanediamine: N,N′-di(sec-butyl)phenylenediamine; piperazine; homopiperazine: methyl-piperazine; and N,N′-di(sec-butyl)phenylenediamine. Preferred diamines are diamines wherein both amine groups are secondary amines.

Lactams are cyclic amides comprising 5 to 13 carbon atoms, wherein one of the carbon atoms is a carbonyl. The amide substituent is typically a tertiary amide. Illustrative lactams are depicted as follows:

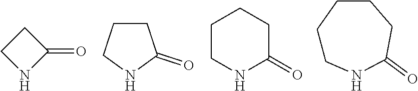

Suitable lactams include for example dodecyl lactam, alkyl substituted dodecyl lactam, caprolactam, and alkyl substituted caprolactam. In some embodiments, the lactam comprises no greater than 8, 7, 6, 5, or 4 carbon atoms.

Aminocarboxylic acids can be linear or branched and may comprise cyclic moieties. Suitable aminocarboxylic acids typically have the same number of carbon atoms as the lactams. Aminocarboxylic acids with secondary amine groups are preferred.

The polyamide-based polyurethane is typically the reaction product of at least one polyamide oligomer and at least one diisocyanate.

In some embodiments, the polyamide-based oligomer comprises at least 50, 60, 70, 80 or 90 wt. % of said polyamide oligomer or telechelic polyamide (e.g. repeat) polymerized units (from diacids and diamines) of the structure

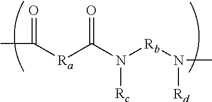

wherein

Ra is a linear, branched or cyclic the alkylene or heteroalkylene moiety (optionally including aromatic groups) having at least 2, 3, or 4 carbon atoms ranging up to 36 carbon atoms; and Ry and Re and R_{d} are the same as previously described.

In some embodiments, the polyamide-based oligomer comprises at least 50, 60, 70, 80 or 90 wt. % of said polyamide oligomer or telechelic polyamide (e.g. repeat) polymerized units (from lactams or amino carboxylic acids) of the structure

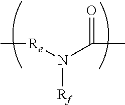

The above described polyamide oligomers and telechelic polyamide are useful to make prepolymers by reacting the polyamide oligomer or telechelic polyamide with polyisocyanates.

Suitable polyisocyanates have an average of about two or more isocyanate groups, preferably an average of about two to about four isocyanate groups per molecule and include aliphatic, cycloaliphatic, araliphatic, aromatic, and heterocyclic polyisocyanates, as well as products of their oligomerization, used alone or in mixtures of two or more. Diisocyanates are more preferred.

Specific examples of suitable aliphatic polyisocyanates include alpha, omega-alkylene diisocyanates having from 5 to 20 carbon atoms, such as hexamethylene-1,6-diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, and the like. Polyisocyanates having fewer than 5 carbon atoms can be used but are less preferred because of their high volatility and toxicity. Preferred aliphatic polyisocyanates include hexamethylene-1,6-diisocyanate, 2,2,4-trimethyl-hexamethylene-diisocyanate, and 2,4,4-trimethyl-hexamethylene diisocyanate.

Specific examples of suitable cycloaliphatic polyisocyanates include dicyclohexylmethane diisocyanate, (commercially available as Desmodur™ W from Bayer Corporation), isophorone diisocyanate, 1,4-cyclohexane diisocyanate, 1,3-bis-(isocyanatomethyl) cyclohexane, and the like. Preferred cycloaliphatic polyisocyanates include dicyclohexylmethane diisocyanate and isophorone diisocyanate.

Specific examples of suitable araliphatic polyisocyanates include m-tetramethyl xylylene diisocyanate, p-tetramethyl xylylene diisocyanate, 1,4-xylylene diisocyanate, 1,3-xylylene diisocyanate, and the like. A preferred araliphatic polyisocyanate is tetramethyl xylylene diisocyanate.

Examples of suitable aromatic polyisocyanates include 4,4′-diphenylmethylene diisocyanate, toluene diisocyanate, their isomers, naphthalene diisocyanate, and the like. Preferred aromatic polyisocyanates include 4,4′-diphenylmethylene diisocyanate and toluene diisocyanate. Examples of suitable heterocyclic isocyanates include 5,5′-methylenebisfurfuryl isocyanate and 5,5′-isopropylidenebisfurfuryl isocyanate.

Polyureas and polyurethanes made from polyamide oligomers or telechelic polyamides are generally hydrophobic and not inherently water-dispersible. Therefore, at least one compound with water-dispersing functionality is typically also included during the synthesis of the prepolymer. Such compounds bear at least one hydrophilic group or a group that can be made hydrophilic, e.g., by chemical modifications such as neutralization, into the polymer/prepolymer chain. These compounds may be characterized as nonionic, anionic, cationic or zwitterionic surfactants. Combination of surfactants may be used. For example, anionic groups such as carboxylic acid groups can be incorporated into the prepolymer and subsequently ionized by a salt-forming compound, such as a tertiary amine defined more fully hereinafter. Anionically dispersible prepolymers/polymers based on carboxylic acid groups generally have an acid number from about 1 to about 60 mgKOH/gram, typically 1 to about 40, or even 10 to 35 or 12 to 30 or 14 to 25 mg KOH/gram. Other water-dispersibility enhancing compounds can also be reacted into the prepolymer backbone through urethane linkages or urea linkages, including lateral or terminal hydrophilic ethylene oxide or ureido units.

Water dispersability enhancing compounds of particular interest are those which can incorporate weak carboxyl groups into the prepolymer. Normally, they are derived from hydroxy-carboxylic acids having the general formula (HO)xQ(COOH)y, wherein Q is a straight or branched hydrocarbon radical containing 1 to 12 carbon atoms, and x and y are 1 to 3. Examples of such hydroxy-carboxylic acids include dimethylol propanoic acid, dimethylol butanoic acid, citric acid, tartaric acid, glycolic acid, lactic acid, malic acid, dihydroxymalic acid, dihydroxytartaric acid, and the like, and mixtures thereof. Dihydroxy-carboxylic acids, such as dimethylol propanoic acid and dimethylol butanoic acid are typically preferred.

Another group of water-dispersability enhancing compounds are side chain hydrophilic monomers. Some examples include alkylene oxide polymers and copolymers in which the alkylene oxide groups have from 2-10 carbon atoms as shown, for example, in U.S. Pat. No. 6,897,281.

Water dispersability enhancing compounds can impart cationic nature onto polyurethane. Cationic polyurethanes contain cationic centers built into or attached to the backbone. Such cationic centers include ammonium, phosphonium and sulfonium groups. These groups can be polymerized into the backbone in the ionic form or, optionally, they can be generated by post-neutralization or post-quaternization of corresponding nitrogen, phosphorous, or sulfur moieties. The combination of all of the above groups can be used as well as their combination with nonionic stabilization. Examples of amines include N-methyldiethanol amine and aminoalcohols available from Huntsman under Jeffcat™ trade name such as DPA, ZF-10, Z-110, ZR-50 and alike. Such amines can make salts with virtually any acid including for example hydrochloric, sulfuric, acetic, phosphoric, nitric, perchloric, citric, tartaric, chloroacetic, acrylic, methacrylic, itaconic, maleic acids, 2-carboxyethyl acrylate and other. Quaternizing agents include methyl chloride, ethyl chloride, alkyl halides, benzyl chloride, methyl bromide, ethyl bromide, benzyl bromide, dimethyl sulfate, diethyl sulfate, chloroacetic, acids and alike. Examples of quaternized diols include dimethyldiethanolammonium chloride and N,N-dimethyl-bis(hydroxyethyl) quaternary ammonium methane sulfonate. Cationic nature can be imparted by other post-polymerization reactions such as, for example, reaction of epoxy quaternary ammonium compounds with carboxylic group of dimethylol propanoic acid.

Other suitable water-dispersability enhancing compounds include thioglycolic acid, 2,6-dihydroxybenzoic acid, sulfoisophthalic acid, polyethylene glycol, and the like, and mixtures thereof.

In typical embodiments, the polyamide-based polyurethane comprises a chemical crosslinking agent. Generally, any suitable crosslinking agent may be used. Exemplary crosslinking agents include covalent crosslinkers such as bisamides, epoxies, melamines, multi-functional amines and aziridines; and ionic crosslinking agents such as metal oxides and organo-metallic chelating agents (e.g., aluminum acetylacetonate). The amount of crosslinking agent included depends on well-understood factors such as the desired degree of crosslinking and the relative effectiveness of the crosslinking agent in the particular system. Crosslinking of the polyurethane using chemical crosslinking agents may be initiated using any conventional technique, such as thermal initiation. In some embodiments, polyurethane adhesives of the present disclosure may include from 0.1 to 10 wt. % of a (e.g. polyaziridine) crosslinker based on the total weight solids (i.e. dried and cured) of the polyurethane. In some embodiments, the amount of (e.g. polyaziridine) crosslinker is no greater than 9, 8, 7, 6, or 5 wt. % solids of the polyurethane second film layer.

The solids contents of polyamide-based PUDs can generally range from about 30 to 40% solids. The viscosity of the polyamide-based PUD is typically at least 50, 100, 200, 300, 400, or 500 cPs. In some embodiments, the viscosity of the polyamide-based PUD is no greater than 1000, 900, 800, 700, 600, or 500 cPs. The viscosity of a PUD (at the same solids content) is indicative of the molecular weight of the dispersed polyamide-based polyurethane.

In some embodiments, the polyamide-based PUD is substantially free of organic solvent. In other embodiments, the polyamide-based PUD has a solvent content less than 1, 0.5, 0.1, or 0.05 wt. % based on the total PUD.

In some embodiments, the polyamide-based PUD has a pH greater than 7. The pH may range be 8, 9 or 10. The amine concentration is typically at least 0.5 or 1 and may range up to 1.5, 2, or 2.5. The acid number of the polyamide-based PUD is typically at least 12 and no greater than 20. In some embodiments, the acid number is no greater than 19, 18, 17, 16, 15, 14, or 13.

In some embodiments, the polyamide-based PUD may be characterized (according to Lubrizol supplier literature) as having a tensile strength of at least 1000, 2000, 3000, 4000, or 5000 psi and typically less than 10,000; 9000, 8000, 7000; or 6,000 psi. In some embodiments, the tensile strength is less than 5000, 4500, 4000, 3500, 3000, or 2500 psi. In some embodiments, the polyamide-based PUD may be characterized (according to Lubrizol supplier literature) as having a tensile modulus of at least 1000, 1500, 2000, 2500, 3000, 3500, or 4000 psi and typically less than 5000 psi. In some embodiments, the tensile modulus is less than 4500, 4000, 3500, 3000, 2500, or 2000 psi.

In some embodiments, the first film layer is a polyurethane layer comprising the reaction product of least one polyisocyanate and at least one polyol.

Examples of suitable polyols include materials commercially available under the trade designation DESMOPHEN from Bayer Corporation (Pittsburgh, PA). The polyols can be polyester polyols (for example, DESMOPHEN 631A, 650A, 651A, 670A, 680, 110, and 1150); polyether polyols (for example, DESMOPHEN 550U, 1600U, 1900U, and 1950U): or acrylic polyols (for example, DEMOPHEN A160SN, A575, and A450BA/A); polycaprolactone polyols such as, for example, those caprolactone polyols available under the trade designation TONE from Dow Chemical Co. (Midland MI) (for example, TONE 200, 201, 230, 2221, 2224, 301, 305, and 310) or under the trade designation CAPA from Solvay (Warrington, Cheshire, United Kingdom) (for example, CAPA 2043, 2054, 2100, 2121, 2200, 2201, 2200A, 2200D, 2100A, 3031, 3091, and 3051)): polycarbonate polyols (for example, those polycarbonate polyols available under the trade designations PC-1122, PC-1167, and PC-1733 from Picassian Polymers (Boston, MA) or under the trade designation DESMOPHEN 2020E from Bayer Corp.); and combinations thereof. In some embodiments, the first film layer comprises polyester moieties.

Suitable polyisocyanates include the same polyisocyanates previously describes for the polyamide-based polyurethanes, Aliphatic including cycloaliphatic polyisocyanates are typically preferred.

If cross-linking is desired, one or more components having at least three functional group (e.g. triisocyanates) is utilized in the polymerization of the polyurethane of the first film layer.

Polyurethanes are generally prepared by the reaction product of diisocyanate and diols. In some embodiments, the polyurethane of the first film layer may be characterized as aliphatic or in other words in the reaction product of one or more aliphatic diols, aliphatic diisocyanates, and one or more components having at least three functional group (e.g. triisocyanates).

In general, the amount of polyisocyanate to polyol is selected in approximately stoichiometrically equivalent amounts, although other ratios may be used (for example, having excess polyisocyanate or excess polyol). Those skilled in the art will recognize that any excess isocyanate present after reaction with the polyol will typically react with materials having reactive hydrogens (for example, adventitious moisture, alcohols, amines, etc.).

A catalyst may be used to facilitate reaction between the polyol and the polyisocyanate. Urethane catalysts are well known in the art and include, for example, tin catalysts (for example, dibutyltin dilaurate).

Multilayer (e.g. protective) films made according to the present invention are useful, for example, as paint protection films.

For paint protection applications, the multilayer film is typically transparent or translucent. The multilayer film may be transparent, translucent, or even opaque for other surface protection or enhancement applications, as desired. For some applications, it may be desirable for the multilayer film to be colored. The multilayer film may be colored, for example, by including a pigment or other coloring agent in one or more of its layers.

When used as a paint protection film, it is typically desirable for the present multilayer film to be sized and shaped to conform to the surface to be protected, before the film is applied. Pre-sized and shaped pieces of the present multilayer film may be commercially desirable for protecting the painted surface of various body parts of a vehicle such as, for example, an automobile, aircraft, watercraft, snowmobile, truck, or train car, especially those portions of the vehicle body (for example, the leading edge of the front hood and other leading surfaces and/or rocker panels) that are exposed to such hazards as flying debris (for example, tar, sand, rocks, and/or insects).

### Method of Making

The method of making a multilayer protective film generally comprises (a) providing a first film layer comprising organic polymeric material, wherein the first film layer has an elongation of at least 200%; (b) forming a second film layer comprising an at least partially crosslinked polyurethane wherein the polyurethane comprises polyamide oligomer moieties; and bonding the first film layer and second film layer.

In some embodiments, the second film layer is prepared by (b1) coating a water-based polyurethane composition onto a release liner; and (b2) drying and curing the water-based polyurethane composition such that the polyurethane is at least partially crosslinked.

The second polyamide-based polyurethane layer may be formed using conventional practices such as, for example, by the aqueous dispersion or solvent solution mixture being cast or otherwise coated onto a releasable carrier web or liner. Those skilled in the art are capable of casting or otherwise coating the aqueous dispersion or solvent solution mixture of the present invention onto a releasable carrier web using known techniques. Suitable carriers may include films such as biaxially oriented polyester and papers that may be coated or printed with a release composition that will enable release from the polyurethane compositions. Such release compositions include those formed from polyacrylics, silicone, and fluorochemicals. The aqueous dispersion or solvent solution mixture may be coated onto a carrier web using conventional equipment known by those skilled in the art such as knife coater, roll coaters, reverse roll coaters, notched bar coaters, curtain coaters, roto-gravure coaters, rotary printer and the like. The viscosity of the aqueous or solvent mixture may be adjusted to the type of coater used. The water or solvent in the coated mixture is then removed such as, for example, by drying.

The second polyamide-based polyurethane layer may be formed, for example, by casting or otherwise coating an aqueous PUD (i.e. polyurethane dispersion) or an organic solvent based polyurethane solution onto a readily releasable carrier web or liner (for example, a polyester carrier web) having a smooth surface. By using such a carrier web or liner having a smooth surface, the resulting polyamide-based polyurethane surface layer also having a smooth surface (e.g. the same smooth surface as the carrier web. Alternatively, when the polyurethane dispersion or solution is applied directly the first film layer and air dried, the surface may or may not be smooth.

In one embodiment, first film layer is formed by melt-extruding a (e.g. polyester-based thermoplastic polyurethane at an elevated temperature through an extrusion die. The TPU layer may also be formed by casting or otherwise molding (for example, injection molding) the polyester-based TPU into the shape desired.

In another embodiment, the first and second layers may be bonded together, for example by laminating the layers with a suitable temperature and pressure. Such laminating may be characterized as cold laminating or heat laminating. In yet other embodiments, the first film layer can be bonded to the second film layer with a (e.g. pressure-sensitive) adhesive layer.

Further details concerning these various method can be found in U.S. Pat. No. 8,551,285 and PCT Pat. Appln. US2006/015699 (Ho et al.), filed Apr. 26, 2006; incorporated herein by reference.

### Examples

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Saint Louis, Missouri, or may be synthesized by conventional methods.

TABLE 1
Materials

| Chemical/Trade Designation | Description |
|---|---|
| APTALON W8060 | Water-borne, self-crosslinking polyurethane dispersion |
| | comprising polyamide polyol, available from Lubrizol |
| | Advanced Materials, Inc., Cleveland, Ohio (36 wt. % solids) |
| APTALON M8100 | Water-borne, self-crosslinking polyurethane dispersion |
| | comprising polyamide polyol, available from Lubrizol |
| | Advanced Materials, Inc., Cleveland, Ohio (37 wt. % solids) |
| TINUVIN-123 | A liquid hindered amine mixture available from BASF, |
| | Florham Park, New Jersey |
| ALBERDINGK U933 | Water-based, polycarbonate-based polyurethane dispersion |
| | available from Alberdingk Boely, Greensboro, North |
| | Carolina |
| AMP-95 | Aminomethyl propanol available from Angus Chemical Co., |
| | Buffalo Grove, Illinois |
| NEOCRYL CX-100 | Polyaziridine available from DSM Coating Resins, LLC, |
| | Wilmington, Massachusetts |
| UVINUL N3039 | A substituted propenoic acid (2-ethylhexyl-2-cyano- |
| | 3,3′diphenyl acrylate), a UV light absorber available from |
| | BASF, Florham Park, New Jersey |
| TRITON GR-7M | Sulfosuccinate-type anionic surfactant available from DOW |
| | Chemicals, Midland, Michigan |
| Butyl carbitol | Available from Eastman Chemical Co., Kingsport, Tennessee |

### Test Methods

### Staining Tests

GM 50% Asphalt Staining Test—The test procedure is based on the standard GM specification test GMW15957. A test fluid was prepared by mixing 50% by volume of Marathon Oil AC-20 non-emulsified asphalt cement in unleaded gasoline. The samples were dipped into the test fluid for 10 seconds and then suspended in a ventilated hood test chamber for 15 minutes, allowing the solution to drain/evaporate. The samples were then thoroughly cleaned with naphtha. The color change before and after the staining test was measured by a Color i5 colorimeter (X-Rite PANTONE, Grand Rapids, Michigan) and Δb yellowing and ΔE total color change were reported.

### Chemical Tests

The chemical, such as sunscreen SPF8, sunscreen SPF 70, 30% phosphoric acid, 1% nitric acid, 1% sulfuric acid, caustic soda was dropped on the film surfaces with a spot size of 10 mm diameter. Then film samples were put in an oven for 30 min at 85° C. The specimens were cleaned thoroughly with detergent and clear water and then dried. Pass means there is no mark left on the surface. Fail means that the film surface was damaged or swollen.

### Elongation at Break Test

The elongation tests were conducted according to ASTM D882, 1 inch strip, jaw gap=1 inch, tested at 12 inches per minute.

### General Examples Preparation

The reactive polyurethane clear coating solution was prepared by mixing 89.30 grams of the respective polyurethane dispersion, 0.35 grams of TINUVIN-123, 0.05 grams AMP-95, 0.20 grams of TRITON GR-7M, 8.5 grams of butyl carbitol, 1.16 grams of UVINUL N3039, 38.0 grams of de-ionized water. For Ex. 3, 1.78 grams (5 wt. % solids) of NEOCRYL CX-100 was added. The solution mixture was thoroughly mixed for about 15 minutes and then coated on the polyurethane surface of a paint protection film, which was then cured in an air oven at temperature 107° C. for 5 mins. The clear coat dry thickness was about 12 microns dry thickness.

TABLE 2
Elongation at Break of Polyamide-based Polyurethanes

| Polyamide Based | Elongation Data from | Elongation after Coated |
|---|---|---|
| Polyurethane | Vendor | on Urethane film |
| Ex. 1 - APTALON | 227% | 365% |
| M8100 | | |
| Ex, 2 - APTALON | 140% | 365% |
| W8060 | | |
| Ex. 3 - APTALON | N/A | 275% |
| W8060 with | | |
| NEOCRYL CX100 | | |
| Crosslinker | | |

TABLE 3
Staining and Chemical Test Results

| Polyurethane | GM | SPF 8 | SPF 70 | 30% | 1% | 1% | Caustic |
|---|---|---|---|---|---|---|---|
| Dispersion | Asphalt | Sunscreen | Sunscreen | H₃PO₄ | HNO₃ | H₂SO₄ | Soda |
| EX-3 | ΔE = 0.90 | Very | Very | Some | Pass | Pass | Pass |
| APTALON | ΔL = −0.06 | slight | slight | Swelling | | | |
| W8060 | Δa = −0.37 | Swelling | Swelling | | | | |
| | Δb = 0.82 | | | | | | |
| CE-1 | ΔE = 5.58 | Swelling | Fail | Fail | Pass | Pass | Pass |
| ALBERDINGK | ΔL = −0.32 | | | | | | |
| U933 with same | Δa = −2.06 | | | | | | |
| amount of | Δb = 5.41 | | | | | | |
| NEOCRYL CX- | | | | | | | |
| 100 as EX-3 | | | | | | | |

1. A multilayer film comprising:
a first film layer comprising an organic polymeric material, wherein the first film layer has an elongation of at least 250%;
a second film layer comprising a crosslinked polyurethane wherein the polyurethane comprises polymerized units of a polyamide.

2. The multilayer film of claim 1 wherein the first film layer has an elongation of at least 300, 350, 400, 450, 500, 550, 650 ranging up to 100%.

3. The multilayer film of claim 1 wherein the organic polymeric material of the first film layer comprises polyurethane.

4. The multilayer film of claim 3 wherein the polyurethane of the first film layer comprises polyester moieties.

5. The multilayer film of claim 1 wherein the polyurethane of the second film layer comprises urea moieties.

6. The multilayer film of claim 3 wherein the first film layer is thermoplastic.

7. The multilayer film of claim 1 wherein the second film layer comprises moieties of a surfactant wherein the surfactant comprises water soluble moieties.

8. The multilayer film of claim 1 wherein the multilayer film is a protection film.

9. The multilayer film of claim 1 wherein the multilayer film further comprises an adhesive disposed on the opposing surface of the first film layer.

10. The multilayer film of claim 9 wherein the adhesive is a pressure sensitive adhesive.

11. A method of protecting a surface of a motor vehicle comprising
providing the multilayer film of claim 10;
bonding the multilayer film to a surface of a motor vehicle by means of the adhesive.

12. The method of claim 11 wherein the surface of the motor vehicle is selected from a door, hood, fender, rocker panel, bumper, mirror, or trunk.

13. A method of making a multilayer protective film, the method comprising steps:
(a) providing a first film layer comprising organic polymeric material, wherein the first film layer has an elongation of at least 200%;
(b) forming a second film layer comprising an at least partially crosslinked polyurethane wherein the polyurethane comprises polyamide oligomer moieties; and
bonding the first film layer and second film layer.

14. The method of claim 13 wherein the first film layer is heat laminated to the second film layer.

15. The method of claim 13 wherein (a) comprises melt-extruding the first film layer onto the second film layer.

16. The method of claim 13 wherein the first film layer is bonded to the second film layer with a pressure sensitive adhesive layer.

17. The method of claim 13 wherein the second film layer is prepared by
(b1) coating a water-based polyurethane composition onto a release liner, and
(b2) drying and curing the water-based polyurethane composition such that the polyurethane is at least partially crosslinked.

18. The method of claim 17 wherein the water-based polyurethane composition further comprises an organic cosolvent.
